(19) United States
(12) Patent Application Publication
(10) Pub. No.: US 2009/0269528 A1
(43) Pub. Date: Oct. 29, 2009

(54) Multilayered stretched hollow material

(75) Inventors: Isao Wada, Chiba-shi (JP); Hidekazu Mitsuhashi, Sodegaura-shi (JP)

Correspondence Address: FOLEY AND LARDNER LLP;SUITE 500, 3000 K STREET NW, WASHINGTON, DC, 20007, US

(73) Assignee: PRIME POLYMER CO., LTD

(21) Appl. No.: 12/310,671

(22) PCT Filed: Sep. 4, 2007
(86) PCT No.: PCT/JP2007/067232

§ 371 Date: Mar. 4, 2009

(30) Foreign Application Priority Data
Sep. 5, 2006 (JP) 2006-240382
Oct. 13, 2006 (JP) 2006-280710
Dec. 27, 2006 (JP) 2006-352984

(51) Int. Cl. B32B 27/08

(52) U.S. Cl. 428/35.7

(57) ABSTRACT

The object of the present invention is to provide a multilayered stretched hollow material having excellent transparency and gas barrier properties. The multilayered stretched hollow material of the present invention is characterized in that it includes surface layers and an intermediate layer wherein the surface layers each contain a propylene polymer composition containing a propylene polymer (the weight thereof being A) and a modified propylene polymer grafted with an unsaturated carboxylic acid or a derivative thereof (the weight thereof being B) in a weight ratio of B/(A+B)≧0.15 and wherein the intermediate layer contains a modified ethylene/vinyl compound copolymer that has a melt flow rate (ASTM D 1238, 210° C., 2.16 kg load) of not less than 8 g/10 min and a crystallization temperature (Tc) of not less than 138° C. and further wherein the multilayered stretched hollow material satisfies C/(A+B+C)≧0.05 wherein C is the weight of the ethylene/vinyl compound copolymer.

### FIELD OF THE INVENTION

The present invention relates to a multilayered stretched hollow material having surface layers based on a propylene polymer and an intermediate layer comprising an ethylene/vinyl compound copolymer. In more detail, the invention relates to a multilayered stretched hollow material having excellent transparency and gas barrier properties.

### BACKGROUND OF THE INVENTION

Polypropylenes have excellent chemical and physical properties and high moldability and are inexpensive. They are therefore used in wide applications including food containers and medical containers.

Polypropylenes have poor gas barrier properties. As a result, food containers made of polypropylene are laminates with ethylene/vinyl alcohol copolymer (EVOH) having high gas barrier properties. Because polypropylene does not adhere well to EVOH, techniques have been proposed to improve the adhesion between polypropylene and EVOH. Patent Documents 1, 2 and 3 disclose that modified polypropylene resins that are grafted with unsaturated carboxylic acids or derivatives thereof (ADMER manufactured by Mitsui Chemicals, Inc.) are used as adhesive layers.

However, stretch blow molded materials made of polypropylene and EVOH with such modified polypropylene resin as an adhesive layer have delamination or stretch wrinkles causing bad appearance or lower transparency. Thus, satisfactory stretch blow molded containers are not obtained.

Containers made of polypropylene alone show good water vapor barrier properties but are poor in oxygen barrier properties. Containers from polyethylene terephthalate (PET) alone have high barrier properties for oxygen but not for water vapor. Accordingly, there is a need for containers having high barrier properties for both water vapor and oxygen.

### Patent Document 1: JP-A-2001-58374

### Patent Document 2: JP-A-2004-82582

### Patent Document 3: JP-A-2002-542077

### DISCLOSURE OF THE INVENTION

The present invention aims to solve the problems associated with the background art as described above. It is therefore an object of the invention to provide multilayered stretched hollow material excellent in transparency and gas barrier properties whereby defects of containers made of polypropylene or PET alone are solved.

A multilayered stretched hollow material according to the present invention comprises surface layers and an intermediate layer, the surface layers each comprising a propylene polymer composition comprising a propylene polymer (I) and a modified propylene polymer (II) grafted with an unsaturated carboxylic acid or a derivative thereof, the intermediate layer comprising an ethylene/vinyl compound copolymer (III), the propylene polymer composition satisfying B/(A+B)≧0.15 wherein A is the content (weight) of the propylene polymer (I) and B is the content (weight) of the modified propylene polymer (II) grafted with an unsaturated carboxylic acid or a derivative thereof, the ethylene/vinyl compound copolymer (III) having a melt flow rate (ASTM D 1238, 210° C., 2.16 kg load) of not less than 8 g/10 min and a crystallization temperature (Tc) of not less than 138° C. (a crystallization peak temperature obtained when the copolymer is cooled from 240° C. at 10° C./min in DSC measurement under a nitrogen atmosphere), the multilayered stretched hollow material satisfying C/(A+B+C)≧0.05 wherein C is the content (weight) of the ethylene/vinyl compound copolymer (III).

### Advantages of the Invention

The multilayered stretched hollow material according to the present invention is excellent in transparency and gas barrier properties and does not have delamination whereby good appearance is ensured. The multilayered stretched hollow material has a specific gravity of approximately 0.9 and provide 30% or more weight saving or weight reduction compared to conventional multilayer bottles or glass containers.

### PREFERRED EMBODIMENTS OF THE INVENTION

### (I) Propylene Polymers

The propylene polymers forming the surface layers of the multilayered stretched hollow material according to the present invention are propylene homopolymers or copolymers of propylene and not more than 5 wt % of α-olefins. The α-olefins include C2-10 α-olefins excluding propylene, such as ethylene, 1-butene, 3-methyl-1-butene, 1-pentene, 3-methyl-1-pentene, 4-methyl-1-pentene, 1-hexene and 1-octene.

The melt flow rate (MFR, ASTM D 1238, 230° C., 2.16 kg load) of the propylene polymers is not particularly limited as long as the polymers can be mixed with the modified propylene polymer described later and be stretch blow molded together. The melt flow rate is generally in the range of 0.5 to 60 g/10 min, preferably 10 to 40 g/10 min, more preferably 15 to 35 g/10 min, and still more preferably 20 to 35 g/10 min.

The propylene polymers are preferably propylene/ethylene random copolymers that contain ethylene-derived units at 0.5 to 5 wt %, more preferably 2.0 to 4.5 wt %, and still more preferably 3.0 to 4.2 wt %.

The use of propylene/ethylene random copolymers having the above melt flow rate and content of ethylene-derived units leads to outstanding transparency as a result of synergistic effects between flowability (moldability) of the obtainable propylene polymer composition and a nucleating agent; further, the obtainable propylene polymer composition is co-injection molded stably with the ethylene/vinyl compound copolymer.

The production of the propylene polymers may involve conventional Ziegler-Natta catalysts or metallocene catalysts without limitation. It is preferable to use metallocene catalysts that essentially contain a metallocene compound represented by Formula (1) below:

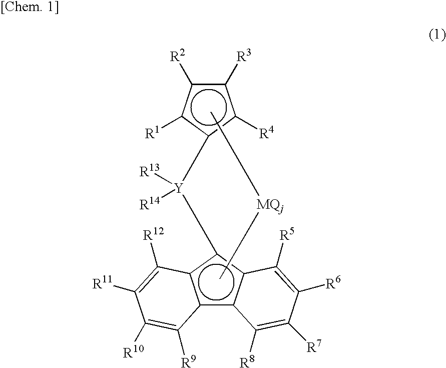

wherein R¹, R², R³, R⁴, R⁵, R⁶, R⁷, R⁸, R⁹, R¹⁰, R¹¹, R¹², R¹³ and R¹⁴ are selected from a hydrogen atom, hydrocarbon groups and silicon-containing groups and may be the same or different from one another; M is a group 4 transition metal; Y is a carbon atom or a silicon atom; Q is a halogen atom, a hydrocarbon group, an anionic ligand or a neutral ligand capable of coordination by lone pair electrons and may be the same or different when plural; and j is an integer of 1 to 4.

Preferred examples of the bridged metallocene compounds illustrated above include isopropylidene(3-tert-butyl-5-methyl-cyclopentadienyl) (fluorenyl)zirconium dichloride, isopropylidene(3-tert-butyl-5-methyl-cyclopentadienyl) (3,6-di-tert-butylfluorenyl)zirconium dichloride, diphenylmethylene(3-tert-butyl-5-methyl-cyclopentadienyl) (fluorenyl)zirconium dichloride, diphenylmethylene(3-tert-butyl-5-methyl-cyclopentadienyl) (2,7-di-tert-butylfluorenyl)zirconium dichloride, diphenylmethylene(3-tert-butyl-5-methyl-cyclopentadienyl) (3,6-di-tert-butylfluorenyl)zirconium dichloride, isopropylidene(3-tert-butyl-5-methylcyclopentadienyl) (octamethyloctahydrodibenzofluorenyl)zirconium dichloride, isopropylidene(3-tert-butyl-5-ethylcyclopentadienyl) (octamethyloctahydrodibenzofluorenyl)zirconium dichloride, diphenylmethylene(3-tert-butyl-5-ethylcyclopentadienyl) (fluorenyl)zirconium dichloride, phenylmethylmethylene (3-tert-butyl-5-ethylcyclopentadienyl) (octamethyloctahydrodibenzofluorenyl) zirconium dichloride and phenylmethylmethylene (3-tert-butyl-5-methylcyclopentadienyl) (octamethyloctahydrodibenzofluorenyl)zirconium dichloride.

The metallocene catalysts include the following components (a) to (c):

(a) the metallocene compound represented by Formula (1) above;

(b) at least one compound selected from:
(b-1) organometallic compounds;
(b-2) organoaluminum oxy-compounds; and
(b-3) compounds capable of reacting with the metallocene compound to form an ion pair; and optionally

(c) a particulate carrier.

Examples of the components (a), (b) and (c) may be found in WO 2005/019283 filed by the present applicant, and those materials described therein may be used without limitation in the present invention.

The use of the propylene polymers produced with the metallocene catalysts as described above results in still improved transparency of the obtainable multilayered stretched hollow material.

### (II) Modified Propylene Polymers

The modified propylene polymers forming the surface layers of the multilayered stretched hollow material according to the present invention are propylene polymers that are grafted with an unsaturated carboxylic acid or a derivative thereof.

The propylene polymers to be graft modified may be of the same category as the propylene polymers (I), and propylene homopolymers are preferable.

Preferred examples of the unsaturated carboxylic acids and derivatives thereof include maleic anhydride. Examples of the modified propylene polymers include ADMER (maleic anhydride-grafted polymer) manufactured by Mitsui Chemicals, Inc.

The modified propylene polymers are preferably grafted with the unsaturated carboxylic acids or derivatives thereof at 0.01 to 5 wt %, more preferably 0.3 to 5 wt %, and still more preferably 0.6 to 5 wt %. The melt flow rate (MFR, ASTM D 1238, 230° C., 2.16 kg load) of the modified propylene polymers is not particularly limited as long as the modified propylene polymers can be mixed with the propylene polymer described hereinabove and be stretch blow molded together. The melt flow rate is generally not less than 3 g/10 min, preferably in the range of 3 to 20 g/10 min, and more preferably 5 to 15 g/10 min.

The modified propylene polymers having the above graft percentage and melt flow rate show good dispersibility with the propylene polymer and greatly contribute to the prevention of reduction in transparency or bond strength with the ethylene/vinyl compound copolymer intermediate layer, thereby providing satisfactory multilayered stretched hollow material.

### (III) Ethylene/Vinyl Compound Copolymers

The ethylene/vinyl compound copolymers forming the intermediate layer of the multilayered stretched hollow material according to the present invention have a melt flow rate (ASTM D 1238, 210° C., 2.16 kg load) of not less than 8 g/10 min, preferably 8 to 30 g/10 min, and more preferably 10 to 20 g/10 min, and a crystallization temperature (Tc) (a crystallization peak temperature obtained when the copolymer is cooled from 240° C. at 10° C./min in DSC measurement under a nitrogen atmosphere) of not less than 138° C., and preferably from 140 to 160° C. It is preferable that the melt flow rate of the ethylene/vinyl compound copolymers is lower than that of the propylene polymers (I).

Ethylene/vinyl compound copolymers having a melt flow rate of less than 8 g/10 min show low flowability, and the performing or stretch blow molding results in an ethylene/vinyl compound copolymer layer with a nonuniform thickness and consequent poor barrier properties. Further, such ethylene/vinyl compound copolymers may be crystallized during co-injection molding with propylene copolymers or the like or in a preheating step prior to stretch blow molding, thus possibly resulting in lower transparency or stretch wrinkles on the obtainable multilayered stretched hollow material. Furthermore, such ethylene/vinyl compound copolymers may adversely affect melt flowability with the propylene polymer and the modified propylene polymer, thus possibly resulting in lower transparency of the obtainable multilayered stretched hollow material.

The ethylene/vinyl compound copolymers according to the present invention are preferably ethylene/vinyl alcohol copolymers, and are more preferably ethylene/vinyl alcohol copolymers modified with epoxy compounds. The epoxy compounds preferably have a molecular weight of not more than 500. Preferred examples of the epoxy compounds include those that form structural units represented by Formula (2) below in the modified vinyl alcohol copolymer. The modified ethylene/vinyl alcohol copolymers have excellent stretchability and do not lower barrier properties or transparency of the obtainable multilayered stretched hollow material.

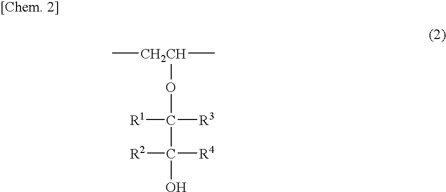

In the above formula, R¹, R², R³ and R⁴ are each a hydrogen atom, a C1-10 aliphatic hydrocarbon group, a C3-10 alicyclic hydrocarbon group or a C6-10 aromatic hydrocarbon group; R¹, R², R³ and R⁴ may be the same or different from one another; R³ and R⁴ may be linked together; and R¹, R², R³ and R⁴ may have a hydroxyl group, a carboxyl group or a halogen atom.

In a preferred embodiment of the present invention, R¹ and R² in the modified ethylene/vinyl alcohol copolymer are both hydrogen atoms. According to a more preferred embodiment, one of R³ and R⁴ in the modified ethylene/vinyl alcohol copolymer is a C1-10 aliphatic hydrocarbon group and the other is a hydrogen atom. In a still more preferred embodiment, one of R³ and R⁴ in the modified ethylene/vinyl alcohol copolymer is a substituent (CH₂)ᵢOH (where i is an integer of 1 to 8) and the other is a hydrogen atom.

The ethylene/vinyl alcohol copolymers are preferably modified with the epoxy compounds at 0.1 to 5.0 mol %, more preferably 0.5 to 2.0 mol %, and still more preferably 1.0 to 1.5 mol %.

The use of the epoxy-modified ethylene/vinyl alcohol copolymers having the above melt flow rate and crystallization temperature leads to containers that are transparent and are free of stretch wrinkles or delamination.

### Propylene Polymer Compositions

The propylene polymer compositions forming the surface layers of the multilayered stretched hollow material according to the present invention contain the propylene polymer (I) and the modified propylene polymer (II). The compositions satisfy B/(A+B)≧0.15 wherein A is the content (weight) of the propylene polymer and B is the content (weight) of the modified propylene polymer. This ratio is preferably in the range of 0.15 to 0.40, and more preferably 0.15 to 0.25. If the ratio indicating the amount of the modified propylene polymer is less than 0.15, the multilayered stretched hollow material will easily have separation between each surface layer and the ethylene/vinyl compound copolymer intermediate layer and the appearance is deteriorated.

The propylene polymer compositions may contain known additives while still achieving the objects of the invention. Such additives include lubricants, neutralizers, antioxidants, and conventional nucleating agents wherein organic phosphates and fatty acid metal salts are dispersing agents with examples including ADEKA Corporation's NA-21.

The propylene polymer and the modified propylene polymer may be mixed with each other optionally together with additives such as phosphorous antioxidants and neutralizers in a Henschel mixer, a twin-cylinder mixer, a tumbler blender or a ribbon blender, and the resultant blend may be melt-kneaded with a single-screw extruder, a multi-screw extruder, a kneader or a Banbury mixer, whereby a high-quality propylene polymer composition in which the polymers and additives are uniformly mixed and dispersed is obtained.

### Multilayered Stretched Hollow Material

The multilayered stretched hollow material of the present invention has surface layers and an intermediate layer wherein the surface layers each comprise the propylene polymer composition comprising the propylene polymer (I) and the modified propylene polymer (II) grafted with an unsaturated carboxylic acid or a derivative thereof, and the intermediate layer comprises the ethylene/vinyl compound copolymer (III). The propylene polymer composition satisfies B/(A+B)≧0.15 wherein A is the content (weight) of the propylene polymer (I) and B is the content (weight) of the modified propylene polymer (II) grafted with an unsaturated carboxylic acid or a derivative thereof. The ethylene/vinyl compound copolymer (III) has a melt flow rate (ASTM D 1238, 210° C., 2.16 kg load) of not less than 8 g/10 min and a crystallization temperature (Tc) of not less than 138° C. (a crystallization peak temperature obtained when the copolymer is cooled from 240° C. at 10° C./min in DSC measurement under a nitrogen atmosphere). The multilayered stretched hollow material satisfies C/(A+B+C)≧0.05 wherein C is the content (weight) of the ethylene/vinyl compound copolymer (III).

The above proportion of the ethylene/vinyl compound copolymer intermediate layer in the multilayered stretched hollow material ensures that the ethylene/vinyl compound copolymer intermediate layer is stably formed. If the proportion is lower than described above, the ethylene/vinyl compound copolymer layer may be cracked after the stretch blow molding and the molded material may fail to maintain gas barrier properties.

The thickness of the surface layers constituted of the propylene polymer composition and the intermediate layer formed from the ethylene/vinyl compound copolymer may be determined appropriately depending on applications of the multilayered stretched hollow material.

The multilayered stretched hollow material may have other layers as long as the surface layers and the intermediate layer are present. Such other layers may be present between the surface layer and the intermediate layer or on one of the surface layers.

The multilayered stretched hollow material of the invention may be produced using a stretch blow molding apparatus which has at least two injection units and is capable of injecting hot runners simultaneously. Generally, the propylene polymer composition to form the surface layers is injected from a main injection unit, and the modified ethylene/vinyl compound copolymer is injected in a predetermined amount from a sub-injection unit and is laminated as an intermediate layer between the propylene polymer compositions, thereby resulting in a preform which has a multilayer structure including three or more layers. The preform is preheated as required and is stretch blow molded to give a multilayered stretched hollow material having high transparency and gas barrier properties. Unlike blow molding (direct blow molding), the stretch blow molding is a process wherein a preform is forcibly stretched lengthwise with a stretching rod or the like and subsequently a pressurizing fluid such as blowing air or nitrogen is injected into the preform and thereby the preform is further stretched lengthwise and crosswise substantially at the same time.

The propylene polymer composition is usually molten and injected at temperatures of 200 to 280° C. The preform temperature immediately before the stretching is approximately 110 to 150° C. The draw ratio is generally 1.5 to 3.0 lengthwise and 1.5 to 3.0 crosswise.

The present invention will be described based on Examples hereinbelow without limiting the scope of the invention.

In Examples, properties were measured by the following methods.

### (1) Haze

The haze was measured in accordance with ASTM D 1003 with respect to a stretch blow molded container through a body side surface of the container (body thickness: 1 mm).

(2) Gas permeability

Samples cut out from a body portion of a stretch blow molded container were tested for water vapor permeability in accordance with JIS K 7129 B, oxygen permeability in accordance with JIS K 7126 B, and carbon dioxide permeability by equal pressure method.

### (3) Crystallization Temperature

A sample weighing 5 mg was placed into a nitrogen-purged measurement container fitted in a differential scanning calorimeter (DSC) and was molten at 240° C. The sample was then cooled at a rate of 10° C./min and the crystallization peak temperature was obtained as the crystallization temperature Tc.

### (4) Appearance Test and Peeling Test

A stretch blow molded container was visually inspected to evaluate the appearance. In detail, the container was inspected for stretch wrinkles and delamination after the container was deformed 20 mm in bottle outer diameter five times.

### (5) Epoxy Modification Percentage

A sample was freeze crushed and subjected to conversion to trifluoroacetyl derivative in accordance with the method described in JP-A-2006-233222. The derivative was analyzed by ¹H-NMR to determine the epoxy modification percentage.

### Example 1

### Preparation of Propylene Polymer Composition

80 wt % of a polypropylene (J246M manufactured by Prime Polymer Co., Ltd., MFR: 30 g/10 min, ethylene-derived unit content: 4.0 wt %) and 20 wt % of a maleic anhydride-grafted polypropylene (ADMER QE800 manufactured by Mitsui Chemicals, Inc., MFR: 9 g/10 min) were mixed together in a tumbler mixer for 10 minutes. The mixture was melt kneaded in a twin-screw extruder to give a propylene polymer composition (PP-1).

### <Production of Stretch Blow Molded Container>

Injection stretch blow molding was performed with an injection stretch blow molding apparatus (ASB-12N/10T manufactured by NISSEI ASB MACHINE CO., LTD.) to produce 100 ml wide-mouth bottles. In detail, the propylene polymer composition (PP-1) was molten at a resin temperature of 200° C. in an injection main unit having a screw diameter of 55 mm. A modified ethylene/vinyl alcohol copolymer (SP295B manufactured by KURARAY CO., LTD., EVOH-1, epoxy modification percentage: 1.1 mol %) was molten at 200° C. in an injection sub-unit having a screw diameter of 20 mm. First, the composition PP-1 was injected from the main unit into a first mold that was temperature-controlled at 15° C. with a water circulation loop attached to the molding apparatus. When a predetermined amount of the composition was injected, EVOH-1 was injected from the sub-unit simultaneously to form an EVOH-1 intermediate layer. The injection from the sub-unit was stopped, and the composition PP-1 alone was injected from the main unit. As a result, a preform was formed in which the EVOH-1 layer was sandwiched between the surface layers. The co-injection was controlled such that the EVOH-1 proportion in the intermediate layer of the preform would be 10 wt %. Herein, the injection pressure was 2 to 10 MPa and the injection time was approximately 8 seconds.

Subsequently, the preform was quickly transferred to a preheating zone and was preheated with a heating pot, and then air was preliminarily blown thereinto. Immediately thereafter, the preform was stretched lengthwise and crosswise with a stretching rod and blowing air to match a blow mold, with a lengthwise draw ratio of 1.5 and a crosswise draw ratio of 1.5. The bottle was cooled, hardened and then ejected. The multilayered stretch blow molded container thus obtained was a cylindrical container that had a mouth diameter of 55.67 mm, a body outer diameter of 66 mm, a bottle height of 64 mm and a capacity of approximately 180 ml.

Properties of the multilayered stretch blow molded container are set forth in Table 1.

### Example 2

A multilayered stretch blow molded container was produced in the same manner as in Example 1 except that the percentage of the EVOH-1 in the intermediate layer of the preform was 18 wt %. Properties of the multilayered stretch blow molded container are set forth in Table 1.

### Example 3

80 wt % of a polypropylene (J207RT manufactured by Prime Polymer Co., Ltd., MFR: 30 g/10 min, ethylene-derived unit content: 2.0 wt %) and 20 wt % of ADMER QE800 manufactured by Mitsui Chemicals, Inc. were mixed together in a tumbler mixer for 10 minutes. The mixture was melt kneaded in a twin-screw extruder to give a propylene polymer composition (PP-2). A multilayered stretch blow molded container was produced in the same manner as in Example 1 except that PP-2 was used in place of PP-1. Properties of the multilayered stretch blow molded container are set forth in Table 1.

### Example 4

A multilayered stretch blow molded container was produced in the same manner as in Example 1 except that EVOH-1 was replaced by a modified ethylene/vinyl alcohol copolymer (SP434A manufactured by KURARAY CO., LTD., EVOH-2, epoxy modification percentage: 1.2 mol %) and that the co-injection was controlled such that the percentage of the EVOH-2 in the preform would be 18 wt %. Properties of the multilayered stretch blow molded container are set forth in Table 1.

### Example 5

### Preparation of Silica-Supported Methylaluminoxane

A thoroughly nitrogen-purged 500 ml reactor was charged with 20 g of silica and 200 ml of toluene, and 60 ml of methylaluminoxane was added dropwise with stirring in the nitrogen atmosphere. The mixture was reacted at 110° C. for 4 hours, and the reaction system was allowed to cool and thereby a solid was precipitated. The supernatant liquid was removed by decantation. The solid was washed three times with toluene and three times with hexane. A silica-supported methylaluminoxane was thus obtained.

### [Preparation of Metallocene Catalyst]

A thoroughly nitrogen-purged 1000 ml two-necked flask was charged with 20 mmol in terms of aluminum atom of the silica-supported methylaluminoxane. The methylaluminoxane was suspended in 500 ml of heptane. To the suspension, a toluene solution containing 70 mg of diphenylmethylene(3-t-butyl-5-methylcyclopentadienyl) (2,7-t-butylfluorenyl)zirconium dichloride was added. Further, triisobutylaluminum (80 mmol) was added, and the mixture was stirred for 30 minutes to give a metallocene catalyst suspension.

### [Production of Random Polypropylene]

The metallocene catalyst suspension was placed in a thoroughly nitrogen-purged 200 L autoclave, and 300 L of liquid propylene and 2.2 kg of ethylene were injected into the autoclave. Further, 10 L of hydrogen was added. Polymerization was performed at 60° C. and a pressure of 3.0 to 3.5 MPa for 60 minutes. When the polymerization ended, methanol was added to complete the polymerization and the autoclave was purged of unreacted propylene. The polymer was collected and vacuum dried at 80° C. for 6 hours to give an ethylene/propylene polymer (PP-3) having MFR of 20 g/10 min and an ethylene content of 5.3 wt %. 80 wt % of the ethylene/propylene polymer (PP-3) and 20 wt % of a maleic anhydride-grafted polypropylene (ADMER QE800 manufactured by Mitsui Chemicals, Inc., MFR: 9 g/10 min) were mixed in a Henschel mixer for 4 minutes together with 0.10 part by weight of IRGAFOS 168, 0.02 part by weight of calcium stearate and 0.25 part by weight of ADEKA's NA-21. The mixture was melt kneaded in a twin-screw extruder to give a propylene polymer composition (PP-4). A multilayered stretch blow molded container was produced in the same manner as in Example 1 except that PP-4 was used in place of PP-1. Properties of the multilayered stretch blow molded container are set forth in Table 1. As shown in Table 1, the multilayered stretch blow molded container of Example 5 which was produced from the metallocene catalyzed ethylene/propylene polymer (PP-3) had high gas barrier properties comparable to the multilayered stretch blow molded containers of Examples 1 and 3 and had higher transparency than the multilayered stretch blow molded containers of Examples 1 and 3.

### Example 6

A multilayered stretch blow molded container was produced in the same manner as in Example 1 except that 85 wt % of the polypropylene (J246M manufactured by Prime Polymer Co., Ltd.) and 15 wt % of the maleic anhydride-grafted polypropylene (ADMER QE800 manufactured by Mitsui Chemicals, Inc.) were mixed together in a tumbler mixer for 10 minutes and the mixture was melt kneaded in a twin-screw extruder to give a propylene polymer composition. Properties of the multilayered stretch blow molded container are set forth in Table 1.

### Comparative Example 1

A multilayered stretch blow molded container was produced in the same manner as in Example 1 except that EVOH-1 was replaced by a modified ethylene/vinyl alcohol copolymer (SP292B manufactured by KURARAY CO., LTD., EVOH-3, epoxy modification percentage: 1.4 mol %). Properties of the multilayered stretch blow molded container are set forth in Table 1.

### Comparative Example 2

A multilayered stretch blow molded container was produced in the same manner as in Example 1 except that EVOH-1 was replaced by a modified ethylene/vinyl alcohol copolymer (SP482B manufactured by KURARAY CO., LTD., EVOH-4, epoxy modification percentage: 1.3 mol %). Properties of the multilayered stretch blow molded container are set forth in Table 1.

### Comparative Example 3

A multilayered stretch blow molded container was produced in the same manner as in Example 1 except that the propylene polymer composition (PP-1) was replaced by a propylene polymer composition that contained 88.9 wt % of polypropylene J246M manufactured by Prime Polymer Co., Ltd. and 11.1 wt % of ADMER QE800 manufactured by Mitsui Chemicals, Inc. Properties of the multilayered stretch blow molded container are set forth in Table 1.

### Comparative Example 4

A multilayered stretch blow molded container was produced in the same manner as in Example 1 except that the propylene polymer composition (PP-1) was replaced by polypropylene J246M manufactured by Prime Polymer Co., Ltd. Properties of the multilayered stretch blow molded container are set forth in Table 1.

### Comparative Example 5

A multilayered stretch blow molded container was produced in the same manner as in Example 1 except that the modified ethylene/vinyl alcohol copolymer (SP295B manufactured by KURARAY CO., LTD., EVOH-1) was replaced by an unmodified ethylene/vinyl alcohol copolymer (G156B manufactured by KURARAY CO., LTD., EVOH-6). Properties of the multilayered stretch blow molded container are set forth in Table 1.

### Reference Example 1

A multilayered stretch blow molded container was produced in the same manner as in Example 1 except that the modified ethylene/vinyl alcohol copolymer (SP295B manufactured by KURARAY CO., LTD., EVOH-1) was replaced by an unmodified ethylene/vinyl alcohol copolymer (E105A manufactured by KURARAY CO., LTD., EVOH-5). Properties of the multilayered stretch blow molded container are set forth in Table 1.

TABLE 1

| | | | | | | | Comp. | Comp. | Comp. | Comp. | Comp. | Ref. |
|---|---|---|---|---|---|---|---|---|---|---|---|---|
| | Ex. 1 | Ex. 2 | Ex. 3 | Ex. 4 | Ex. 5 | Ex. 6 | Ex. 1 | Ex. 2 | Ex. 3 | Ex. 4 | Ex. 5 | Ex. 1 |
| Polypropylene J246M (wt %) | 72 | 65.6 | | 65.6 | | 76.5 | 72 | 72 | 80 | 90 | 72 | 72 |
| Polypropylene J207RT (wt %) | | | 72 | | | | | | | | | |
| PP-4 (wt %) | | | | | 72 | | | | | | | |
| Grafted polymer ADMER QE800 | 18 | 16.4 | 18 | 16.4 | 18 | 13.5 | 18 | 18 | 10 | | 18 | 18 |
| (wt %) | | | | | | | | | | | | |
| EVOH-1 (SP295B) (wt %) | 10 | 18 | 10 | | 10 | 10 | | | 10 | 10 | | |
| EVOH-2 (SP434A) (wt %) | | | | 18 | | | | | | | | |
| EVOH-3 (SP292B) (wt %) | | | | | | | 10 | | | | | |
| EVOH-4 (SP482B) (wt %) | | | | | | | | 10 | | | | |
| EVOH-5 (E105A) (wt %) | | | | | | | | | | | | 10 |
| EVOH-6 (G156B) (wt %) | | | | | | | | | | | 10 | |
| MFR of EVOH (g/10 min) | 12 | 12 | 12 | 11 | 12 | 12 | 4.5 | 4.1 | 12 | 12 | 15 | 13 |
| Crystallization peak temperature | 140.8 | 140.8 | 140.8 | 153.3 | 140.8 | 140.8 | 136.5 | 152.0 | 140.8 | 140.8 | 134.5 | 141.8 |
| (Tc) of EVOH (° C.) | | | | | | | | | | | | |
| B/(A + B) | 0.20 | 0.20 | 0.20 | 0.20 | 0.20 | 0.15 | 0.20 | 0.20 | 0.111 | 0 | 0.20 | 0.20 |
| C/(A + B + C) | 0.10 | 0.18 | 0.10 | 0.18 | 0.10 | 0.10 | 0 | 0 | 0.10 | 0.10 | 0 | 0.10 |
| Oxygen gas permeability | 1.59 | 0.90 | 1.58 | 0.25 | 1.59 | 1.59 | 90 | 105 | 108 | 110 | 130 | 110 |
| (cc/mm/m²/day · atm) | | | | | | | | | | | | |
| Carbon dioxide gas permeability | 12 | 7.5 | 11 | 7.4 | 11 | 12 | 400 | 420 | 460 | 510 | 490 | 480 |
| (cc/mm/m²/day · atm) | | | | | | | | | | | | |
| Water vapor permeability | 0.52 | 0.50 | 0.51 | 0.52 | 0.52 | 0.52 | 0.58 | 0.57 | 0.59 | 0.60 | 0.60 | 0.60 |
| (g/mm/m²/day · atm) | | | | | | | | | | | | |
| Haze through side surface of | 3 | 3 | 4 | 3 | 1 | 3 | 16 | 25 | 4 | 30 | 50 | 30 |
| stretch blow molded bottle (%) | | | | | | | | | | | | |
| Appearance of stretch blow molded | None | None | None | None | None | None | Found | Found | None | Found | Found | Found |
| container (stretch wrinkles) | | | | | | | | | | | | |
| Deforming separation in stretch | None | None | None | None | None | None | None | None | Found | Found | Found | Found |
| blow molded article (delamination) | | | | | | | | | | | | |

The results in Table 1 show that the multilayered stretched hollow materials (multilayered stretch blow molded containers) according to the present invention achieve transparency, moldability and gas barrier properties because of the three polymer components in the specific composition ratios. This advantage cannot be reached by conventional art alone, and the multilayered stretch blow molded containers of the invention prove an inventive step over the conventional art. The multilayered stretched hollow materials (multilayered stretch blow molded containers) of the present invention are very light compared to glass and do not cause injuries when they are broken. Thus, the containers of the invention are highly useful.

### INDUSTRIAL APPLICABILITY

The propylene polymer, the modified propylene polymer and the modified ethylene/vinyl compound copolymer have carefully considered melting points, crystallization properties and flowability. They show excellent stretchability in stretch molding at a wide range of stretching temperatures and produce containers having uniform thickness. The multilayered stretched hollow material of the invention is lightweight and transparent and has gas barrier properties. It is accordingly suited for use as a container for food, seasonings, beverages, cosmetics and the like.

1. A multilayered stretched hollow material comprising surface layers and an intermediate layer,
the surface layers each comprising a propylene polymer composition comprising a propylene polymer (I) and a modified propylene polymer (II) grafted with an unsaturated carboxylic acid or a derivative thereof,
the intermediate layer comprising an ethylene/vinyl compound copolymer (III),
the propylene polymer composition satisfying B/(A+B)≧0.15 wherein A is the content (weight) of the propylene polymer (I) and B is the content (weight) of the modified propylene polymer (II) grafted with an unsaturated carboxylic acid or a derivative thereof,
the ethylene/vinyl compound copolymer (III) having a melt flow rate (ASTM D 1238, 210° C., 2.16 kg load) of not less than 8 g/10 min and a crystallization temperature (Tc) of not less than 138° C. (a crystallization peak temperature obtained when the copolymer is cooled from 240° C. at 10° C./min in DSC measurement under a nitrogen atmosphere),
the multilayered stretched hollow material satisfying C/(A+B+C)≧0.05 wherein C is the content (weight) of the ethylene/vinyl compound copolymer (III).

2. The multilayered stretched hollow material according to claim 1, wherein the ethylene/vinyl compound copolymer is an ethylene/vinyl alcohol copolymer.

3. The multilayered stretched hollow material according to claim 1, wherein the ethylene/vinyl compound copolymer is an ethylene/vinyl alcohol copolymer modified with an epoxy compound.

4. The multilayered stretched hollow material according to claim 1, wherein the propylene polymer is a propylene/ethylene random copolymer that contains 0.5 to 5 wt % of ethylene-derived units.

5. The multilayered stretched hollow material according to claim 1, wherein the propylene polymer is produced with a metallocene catalyst that essentially contains a metallocene compound of Formula (1) below: 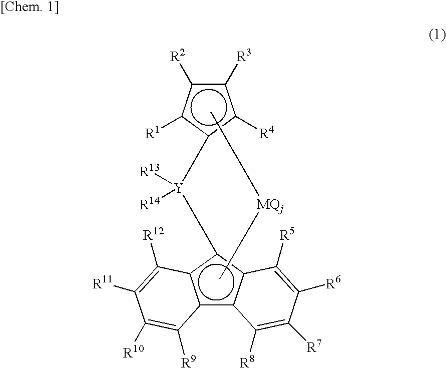
wherein R¹, R², R³, R⁴, R⁵, R⁶, R⁷, R⁸, R⁹, R¹⁰, R¹¹, R¹², R¹³ and R¹⁴ are selected from a hydrogen atom, hydrocarbon groups and silicon-containing groups and may be the same or different from one another; M is a group 4 transition metal; Y is a carbon atom or a silicon atom; Q is a halogen atom, a hydrocarbon group, an anionic ligand or a neutral ligand capable of coordination by lone pair electrons and may be the same or different when plural; and j is an integer of 1 to 4.
